(19) United States
(12) Patent Application Publication
(10) Pub. No.: US 2024/0154261 A1
(43) Pub. Date: May 9, 2024

(54) ELECTROCHEMICAL DEVICE AND ELECTRONIC DEVICE CONTAINING SAME

(71) Applicant: Ningde Amperex Technology Limited, Ningde City (CN)

(72) Inventors: Ning Liu, Ningde City (CN); Yu Ding, Ningde City (CN); Daolin Liu, Ningde City (CN)

(73) Assignee: Ningde Amperex Technology Limited, Ningde City (CN)

(21) Appl. No.: 18/411,279

(22) Filed: Jan. 12, 2024

Related U.S. Application Data
(63) Continuation of application No. PCT/CN2021/106542, filed on Jul. 15, 2021.

(51) Int. Cl. H01M 50/533; H01M 10/0525; H01M 50/244; H01M 50/48; H01M 50/538

(52) U.S. Cl. CPC H01M 50/533; H01M 50/244; H01M 50/48; H01M 50/538; H01M 10/0525

(57) ABSTRACT

An electrochemical device and an electronic device containing the electrochemical device. With a first accommodation portion disposed in the electrochemical device, a specific accommodation space is provided for a bend portion of a first tab, thereby avoiding a need to additionally increasing space for accommodating the bend portion, where the space is originally intended for accommodating the electrode assembly. This effectively saves the space occupied by the tab in the packaging shell, reduces the size of the electrochemical device, and improves an energy density of the electrochemical device. The electronic device also achieves a high energy density.

### CROSS-REFERENCE TO RELATED APPLICATION

This application is a continuation of International Patent Application No. PCT/CN2021/106542, filed on Jul. 15, 2021, the disclosure of which is hereby incorporated by reference in its entirety.

### TECHNICAL FIELD

This application relates to the electrochemical field, and in particular, to an electrochemical device and an electronic device containing same.

### BACKGROUND

Lithium-ion batteries are widely used in products such as a camera, a power tool, and an electric vehicle. It is urgent to increase the operating voltage of a lithium-ion battery to meet higher requirements posed in the market.

An existing method for increasing the operating voltage of the lithium-ion battery is to dispose two electrode assemblies in the same packaging shell. A piece of metal foil protruding out of a current collector usually needs to be bent and stacked and then welded to a current collecting plate so as to serve as a tab of the electrode assembly, thereby leading the polarity out of the packaging shell. In order to prevent the long tab from occupying the space in the shell, the tab usually needs to be bent. However, a weld mark region is hardly bendable due to high thickness and rigidity. When the electrode assembly is relatively thin, if the tab is bent from a part outside the weld mark region, the bend section will exceed the surface of the electrode assembly in height. In this case, if the tab is directly led out of the packaging shell, the bend section will occupy a large amount of space in the shell, thereby reducing the energy density of the lithium battery.

### SUMMARY

This application provides an electrochemical device and an electronic device containing same to increase an energy density thereof.

It is hereby noted that in the description of this application, this application is construed by using a lithium-ion battery as an example of an electrochemical device, but the electrochemical device according to this application is not limited to the lithium-ion battery. Specific technical solutions are as follows:

A first aspect of this application provides an electrochemical device. The electrochemical device includes a packaging shell, a spacer plate, a first electrode assembly, a second electrode assembly, a first tab, and a second tab. The packaging shell includes a first packaging body and a second packaging body. The spacer plate is disposed between the first packaging body and the second packaging body. Two surfaces of the spacer plate are hermetically connected to the first packaging body and the second packaging body respectively, so as to define a first cavity and a second cavity on two sides of the spacer plate respectively. The first electrode assembly and the second electrode assembly are disposed in the first cavity and the second cavity correspondingly. The first tab is connected to the first electrode assembly, and the second tab is connected to the second electrode assembly. Along a thickness direction of the first electrode assembly, a first bend portion is disposed on the first tab. A height of the first bend portion is greater than a thickness of the first electrode assembly. The height of the first bend portion is a maximum distance from the first bend portion to a surface of the first electrode assembly in the thickness direction of the first electrode assembly, the surface facing the first packaging body. A first accommodation portion protruding toward the second packaging body is disposed on the spacer plate, and the first bend portion is disposed in the first accommodation portion.

In the electrochemical device provided in this application, with a first accommodation portion disposed, a specific accommodation space is provided for a bend portion of a first tab, thereby avoiding a need to additionally increasing space for accommodating the bend portion, where the space is originally intended for accommodating the first electrode assembly. This effectively saves the space of the packaging shell of the tab, reduces the size of the electrochemical device, and improves an energy density of the electrochemical device.

In some embodiments of this application, the first tab further includes a first section connected to the first bend portion. The first section protrudes out of the packaging shell after passing through a sealed region between the spacer plate and the first packaging body, so as to connect the first electrode assembly and the second electrode assembly in series or serve as a positive/negative electrode terminal for implementing charge-and-discharge connection.

In some embodiments of this application, a second recessed portion configured for steping aside the first accommodation portion is disposed on the second packaging body. The second recessed portion is hermetically connected to the first accommodation portion. A first bulge in fit with the first accommodation portion is disposed on the first packaging body. The first section extends out of the packaging shell from between the first bulge and the first accommodation portion. In this way, the spacer plate can be hermetically connected to the first packaging body and the second packaging body separately to improve the sealing reliability of the electrochemical device.

In some embodiments of this application, the first tab further includes a second bend portion. The second bend portion is connected to the first bend portion and the first section. A height of the second bend portion is less than a height of the first bend portion along the thickness direction of the first electrode assembly. The height of the second bend portion is a distance from the surface of the first electrode assembly to a lowest point of the second bend portion, the surface facing the first packaging body. With the design of the second bend portion, after the electrochemical device is sealed, a plurality of protruding tabs are caused to be in the same plane, thereby eliminating the need of an additional process by which a seal edge of the first packaging body and a seal edge of the second packaging body form a matching recessed portion or bulge, thereby saving manufacturing cost while increasing the energy density of the electrochemical device.

In some embodiments of this application, along the thickness direction of the first electrode assembly, a longitudinal section of the first accommodation portion is U-shaped. Both the first bend portion and second bend portion are disposed in the first accommodation portion. The first section extends out of the packaging shell from between an edge of the spacer plate and the first packaging body. With the first accommodation portion disposed, an accommodation space is provided for the first bend portion and the second bend portion, thereby ensuring the sealing reliability of the electrochemical device while reducing the size of the electrochemical device to increase the energy density.

In some embodiments of this application, a number of the first tabs is identical to a number of the first accommodation portions, and the first tabs correspond one-to-one to the first accommodation portions; or, a number of the first tabs is greater than a number of the first accommodation portions, and at least one first accommodation portion corresponds to two or more first tabs.

In some embodiments of this application, the number of the first tabs is two, and the two first tabs are of opposite polarities. The number of the first accommodation portions is two, and the first tabs correspond to the first accommodation portions respectively; or, the number of the first accommodation portions is one, and two first tabs correspond to the same first accommodation portion.

In some embodiments of this application, the spacer plate includes an interlayer and a bonding layer located on a surface of the interlayer. The bonding layer is disposed at least in an edge region of the interlayer on all sides, so as to effectively enhance the sealing reliability of the electrochemical device.

In some embodiments of this application, the interlayer is made of a material including at least one of a metal material, a polymer material, or a carbon material.

In some embodiments of this application, the metal material includes at least one of Ni, Ti, Ag, Au, Pt, Fe, Co, Cr, W, Mo, Pb, In, Zn, Al, stainless steel, or an alloy thereof. The polymer material includes at least one of polyethylene terephthalate, polybutylene terephthalate, polyethylene glycol naphthalate, polyether ether ketone, polyimide, polyamide, polyethylene glycol, polyamide imide, polycarbonate, cyclic polyolefin, polyphenylene sulfide, polyvinyl acetate, polytetrafluoroethylene, polymethylene naphthalene, polyvinylidene difluoride, polyethylene naphthalate, polypropylene carbonate, poly(vinylidene difluoride-hexafluoropropylene), poly(vinylidene difluoride-co-chlorotrifluoroethylene), organosilicon, vinylon, polypropylene, acid anhydride modified polypropylene, polyethylene, ethylene and a copolymer thereof, polyvinyl chloride, polystyrene, polyether nitrile, polyurethane, polyphenylene ether, polyester, polysulfone, poly(amorphous a-co-olefin), or a derivative thereof. The carbon material includes at least one of carbon felt, carbon film, carbon black, acetylene black, fullerene, conductive graphite film, or graphene film.

A second aspect of this application provides an electronic device, including the electrochemical device according to the first aspect of this application. Therefore, the electronic device of this application also achieves a high energy density.

### BRIEF DESCRIPTION OF DRAWINGS

To describe the technical solutions in the embodiments of this application or the prior art more clearly, the following outlines the drawings to be used in the embodiments of this application or the prior art. Evidently, the drawings outlined below are merely a part of embodiments of this application.

FIG. 1 is a schematic structural diagram of an electrochemical device according to some embodiments of this application;

FIG. 2 is a schematic structural exploded view of the electrochemical device shown in FIG. 1;

FIG. 3 is a schematic structural diagram of a first electrode assembly shown in FIG. 2;

FIG. 4 is a schematic structural diagram of a region A shown in FIG. 3;

FIG. 5 is a schematic structural diagram of a spacer plate shown in FIG. 2;

FIG. 6 is a close-up view of a schematic structure of a sealing position, shown in FIG. 1, of a first tab and an electrode assembly;

FIG. 7 is a schematic structural diagram of an electrochemical device according to another embodiment of this application;

FIG. 8 is a schematic structural exploded view of the electrochemical device shown in FIG. 7;

FIG. 9 is a schematic structural diagram of a spacer plate shown in FIG. 8;

FIG. 10 is a schematic structural diagram of a region B shown in FIG. 8;

FIG. 11 is a schematic structural diagram of an electrochemical device according to still another embodiment of this application.

FIG. 12 is a schematic structural exploded view of the electrochemical device shown in FIG. 11;

FIG. 13 is a schematic structural diagram of a spacer plate shown in FIG. 12;

FIG. 14 is a close-up view of a schematic structure of a sealing position, shown in FIG. 12, of a first tab and an electrode assembly;

FIG. 15 is a schematic structural diagram of a region C shown in FIG. 12;

FIG. 16 is a schematic structural diagram of a region D shown in FIG. 12; and

FIG. 17 is a schematic structural diagram of a spacer plate according to some embodiments of this application.

List of reference numerals: 10. electrochemical device; 21. first electrode assembly; 22. second electrode assembly; 30. spacer plate; 31. interlayer; 32. bonding layer; 301. first accommodation portion; 302. second accommodation portion; 40. packaging shell; 41. first packaging body; 411. first bulge; 412. first recessed portion; 42. second packaging body; 421. second bulge; 422. second recessed portion; 51. first tab; 511. first positive tab; 512. first negative tab; 513. first bend portion; 514. first section; 515. second bend portion; 52. second tab; 521. second positive tab; 522. second negative tab; 523. third bend portion; 524. second section; 525. fourth bend portion

### DETAILED DESCRIPTION

To make the objectives, technical solutions and advantages of this application clearer, the following describes this application in further detail with reference to drawings and embodiments. Evidently, the described embodiments are merely a part of but not all of the embodiments of this application. All other embodiments derived by a person of ordinary skill in the art based on the embodiments of this application without making any creative efforts still fall within the protection scope of this application.

It is hereby noted that in specific embodiments of this application, this application is construed by using a lithium-ion battery as an example of the electrochemical device, but the electrochemical device according to this application is not limited to the lithium-ion battery. Specific technical solutions are as follows:

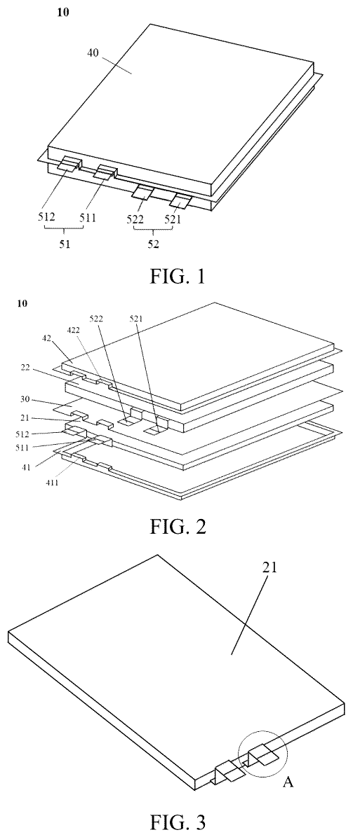

As shown in FIG. 1 to FIG. 6, an embodiment in a first aspect of this application provides an electrochemical device 10. The electrochemical device includes a packaging shell 40, a spacer plate 30, a first electrode assembly 21, a second electrode assembly 22, a first tab 51, and a second tab 52. The packaging shell 40 includes a first packaging body 41 and a second packaging body 42. The spacer plate 30 is disposed between the first packaging body 41 and the second packaging body 42. Two surfaces of the spacer plate 30 are hermetically connected to the first packaging body 41 and the second packaging body 42 respectively, so as to define a first cavity (not shown in the drawings) and a second cavity (not shown in the drawings) on two sides of the spacer plate 30 respectively. The first electrode assembly 21 and the second electrode assembly 22 are disposed in the first cavity and the second cavity correspondingly. That is, the first electrode assembly 21 is disposed in the first cavity, and the second electrode assembly 22 is disposed in the second cavity.

The first tab 51 is connected to the first electrode assembly 21, and the second tab 52 is connected to the second electrode assembly 22. Along a thickness direction of the first electrode assembly 21, a first bend portion 513 is disposed on the first tab 51. A height H₂ of the first bend portion 513 is greater than a thickness H₁ of the first electrode assembly 21. A first accommodation portion 301 protruding toward the second packaging body is disposed on the spacer plate 30. The first bend portion 513 is disposed in the first accommodation portion 301.

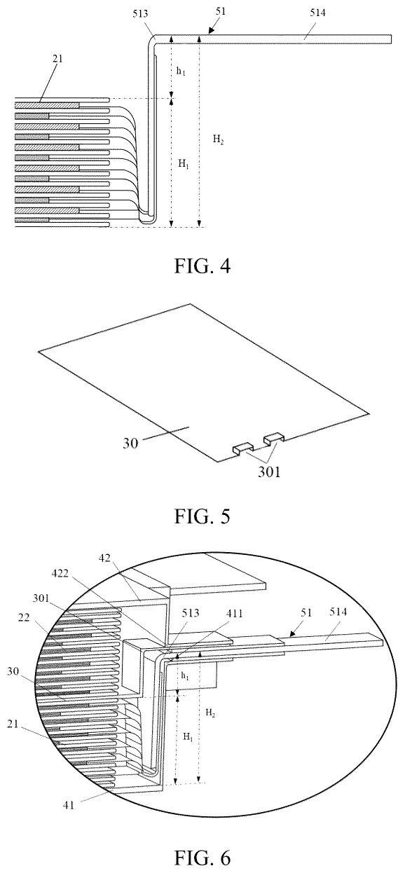

Understandably, as shown in FIG. 4, a plurality of bend portions are formed on the first tab 51. Along the thickness direction of the first electrode assembly 21, the first bend portion 513 is located above the main body of the first electrode assembly 21. That is, the height of the first bend portion 513 is greater than the thickness of the first electrode assembly 21. The height H₂ of the first bend portion 513 is a maximum distance from a surface of the first electrode assembly 21 to the first bend portion 513 in the thickness direction (the vertical direction in the drawing) of the first electrode assembly 21, the surface facing the first packaging body 41. In other words, the height H₂ of the first bend portion 513 is a distance from a surface of the first electrode assembly 21 to a highest point of the first bend portion 513, the surface facing the first packaging body 41. To be specific, as shown in FIG. 4, along the thickness direction of the first electrode assembly 21, H₂ is the maximum distance from the first bend portion 513 to a lower surface of the first electrode assembly 21.

Further, understandably, the thickness of the first electrode assembly 21 is a distance from one surface of the first electrode assembly 21 to another surface of the first electrode assembly 21, where the one surface faces the first packaging body 41, and the other surface faces the spacer plate 30. To be specific, as shown in FIG. 4, along the thickness direction (the vertical direction in the drawing) of the first electrode assembly 21, H₁ is a distance from the upper surface of the first electrode assembly 21 to the lower surface of the first electrode assembly.

Using a first electrode assembly connected to a first tab as an example, in this application, a method for measuring the thickness is: placing the first electrode assembly connected to the first tab on a horizontal worktable horizontally, so that the thickness direction of the first electrode assembly is a vertical direction; measuring the distance from the lower surface to the upper surface of the first electrode assembly by use of a thickness gauge, and using the measured distance as the thickness H₁ of the first electrode assembly; using a bend portion located above the main body of the first electrode assembly in the first tab as a first bend portion, measuring the distance from the highest point of the first bend portion to the lower surface, and using the measured distance as the height H₂ of the first bend portion.

In the electrochemical device 10 of this application, referring to FIG. 6, in order to prevent the long first tab 51 from occupying the space in the shell, the first tab 51 extends out of the packaging shell after being bent inside the shell. The first electrode assembly 21 is relatively thin, thereby making the height of a part of the bend portion exceed the main body of the first electrode assembly 21. Specifically, the height H₂ of the first bend portion 513 shown in FIG. 6 is greater than the thickness H₁ of the first electrode assembly 21. In this case, if a flat and even spacer plate 30 is used for sealing, then the space of the first cavity has to be increased in order to accommodate the first bend portion 513. In this application, a first accommodation portion 301 protruding toward the second packaging body 42 is disposed on the spacer plate 30, so that the first bend portion 513 is disposed in the first accommodation portion 301, thereby avoiding a need to additionally increase the space of first cavity for accommodating the first bend portion 513, where the space is originally intended for accommodating the first electrode assembly 21. This effectively saves the space of the packaging shell of the tab, reduces the size of the electrochemical device 10, and increases the energy density of the electrochemical device 10.

As shown in FIG. 1, FIG. 2, and FIG. 4, in some embodiments of this application, the first tab 51 further includes a first section 514 connected to the first bend portion 513. The first section 514 extends out of the packaging shell 40, and serves to connect the first electrode assembly 21 and the second electrode assembly 22 in series or serves as a positive/negative electrode terminal for implementing charge-and-discharge connection.

In some embodiments of this application, as shown in FIG. 1 to FIG. 2, a second recessed portion 422 configured for steping aside the first accommodation portion 301 is formed on a seal edge of the second packaging body 42. A recessed wall of the second recessed portion 422 is hermetically connected to the first accommodation portion 301. A first bulge 411 in fit with the first accommodation portion 301 is formed on the seal edge of the first packaging body 41. The first bulge 411 is hermetically connected to the first accommodation portion 301. The first section 514 of the first tab 51 extends out of the packaging shell 40 from between the first bulge 411 and the first accommodation portion 301. In this way, the spacer plate 30 can be hermetically connected to the first packaging body 41 and the second packaging body 42 separately to improve the sealing reliability of the electrochemical device 10.

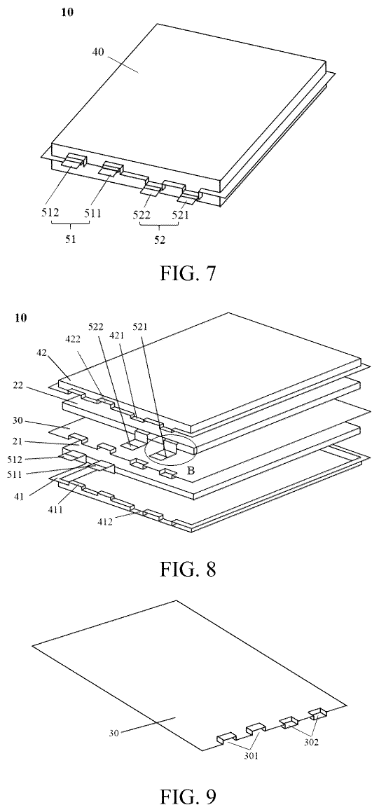

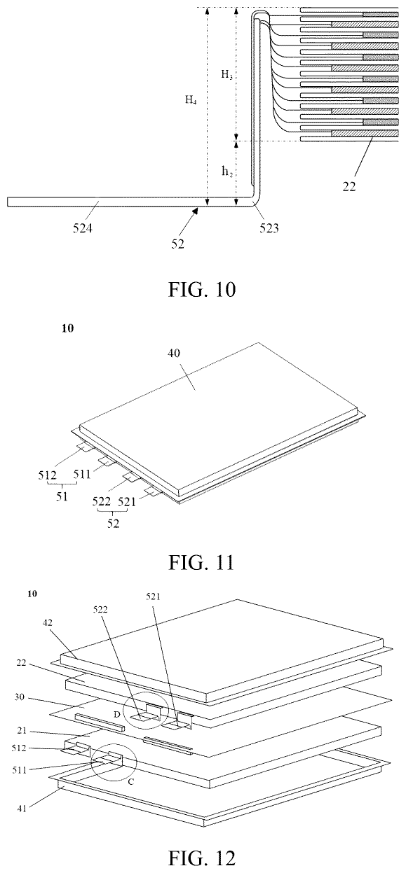

In some embodiments of this application, as shown in FIG. 7 to FIG. 10, along the thickness direction of the second electrode assembly 22, a third bend portion 523 is formed on the second tab 52. The height H₄ of the third bend portion 523 is greater than the thickness H₃ of the second electrode assembly. The height of the third bend portion 523 is a distance H₄ from a surface of the second electrode assembly 22 to the highest point of the third bend portion 523, the surface facing the second packaging body 42 (understandably, during a height test, the second electrode assembly 22 is placed in a direction opposite to the direction shown in FIG. 10, and the third bend portion 523 is located above the main body of the second electrode assembly 22, and therefore, the third bend portion 523 possesses the highest point). The thickness of the second electrode assembly 22 is A distance H₃ from one surface of the second electrode assembly 22 to another surface of the second electrode assembly 22, where the one surface faces the second packaging body 42, and the other surface faces the spacer plate 30. A second accommodation portion 302 protruding toward the first packaging body 41 is formed on the spacer plate 30, and the third bend portion 523 of the second tab 52 is disposed in the second accommodation portion 302. This effectively saves the space occupied by the second tab 52 inside the packaging shell 40, and increases the energy density of the electrochemical device 10.

Further, as shown in FIG. 10, the second tab 52 further includes a second section 524 connected to the third bend portion 523. The second section 524 extends out of the packaging shell 40, and serves to connect the first electrode assembly 21 and the second electrode assembly 22 in series or serves as a positive/negative electrode terminal for implementing charge-and-discharge connection.

Further, as shown in FIG. 8 to FIG. 9, a first recessed portion 412 configured to avoid the second accommodation portion 302 is formed on a seal edge of the first packaging body 41. A recessed wall of the first recessed portion 412 is hermetically connected to the second accommodation portion 302. A second bulge 421 in fit with the second accommodation portion 302 is formed on the seal edge of the second packaging body 42. The second bulge 412 is hermetically connected to the second accommodation portion 302. The second section 524 of the second tab 52 extends out of the packaging shell 40 from between the second bulge 421 and the second accommodation portion 302. In this way, the spacer plate 30 can be hermetically connected to the first packaging body 41 and the second packaging body 42 separately to improve the sealing reliability of the electrochemical device 10.

In some embodiments of this application, as shown in FIG. 14 to FIG. 15, the first tab 51 further includes a second bend portion 515. The second bend portion 515 is connected to the first bend portion 513 and the first section 514. A height of the second bend portion 515 is less than a height of the first bend portion 513 along the thickness direction of the first electrode assembly 21. The height of the second bend portion 515 is a distance H₅ from the surface of the first electrode assembly 21 to a lowest point of the second bend portion 515, the surface facing the first packaging body 41. In this way, a part by which the first tab 51 is higher than the first electrode assembly 21 can be folded back to one side of the spacer plate 30 that is adjacent to the first electrode assembly 21, become flush with this side of the spacer plate 30, and then extend out of the packaging shell 40 by keeping in close fit with the spacer plate 30, thereby disposing the first bend portion 513 and the second bend portion 515 into the first accommodation portion 301. The first section 514 extends out of the packaging shell from between the edge of the spacer plate 30 and the seal edge of the second packaging body. In this way, the first accommodation portion 301 avoids additionally increases the space of the first cavity for accommodating the first bend portion 513 and the second bend portion 515, where the space is originally intended for accommodating the first electrode assembly 21, thereby more efficiently utilizing the space inside the packaging shell, and increasing the energy density of the electrochemical device. In addition, with the design of the second bend portion 515, a plurality of protruding tabs in the same electrode assembly are caused to be in the same plane, thereby eliminating the need of an additional process by which a seal edge of the first packaging body 41 and a seal edge of the second packaging body 42 form a matching recessed portion or bulge, thereby saving manufacturing cost while increasing the energy density of the electrochemical device 10.

Further, when the height of the second tab 52 connected to the second electrode assembly 22 is less than or equal to the thickness of the second electrode assembly 22, the second tab 52 can extend directly out of the packaging shell 40 in a manner of being parallel to and keeping in close fit with the spacer plate 30, without a need to form the first bend portion 513 and/or the second bend portion 515. Accordingly, when the second tab 52 is extended out of the packaging shell 40 from between the edge of the spacer plate 30 and the seal edge of the second packaging body 42, no recessed portion or bulge needs to be formed on the spacer plate 30, the seal edge of the first packaging body 41, or the seal edge of the second packaging body 42. During packaging of the electrochemical device 10, the seam between the spacer plate 30 and the packaging shell 40 is flat, even, and sealed.

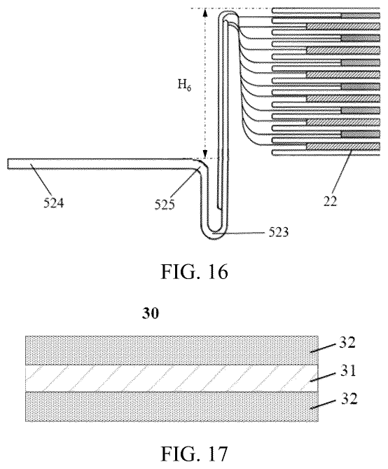

In some embodiments of this application, as shown in FIG. 12 and FIG. 16, the second tab 52 includes a fourth bend portion 525. The fourth bend portion 525 is connected to the third bend portion 523 and the second section 524. A height of the fourth bend portion 525 is less than a height of the third bend portion 523 along the thickness direction of the second electrode assembly 22. The height of the fourth bend portion 525 is a distance H₆ from the surface of the second electrode assembly 22 to a lowest point of the fourth bend portion 525, the surface facing the second packaging body 42 (understandably, during height measurement, the second electrode assembly 22 is placed in a direction opposite to the direction shown in FIG. 16, and the third bend portion 523 is located above the main body of the second electrode assembly 22, and therefore, the third bend portion 523 possesses a highest point, and the fourth bend portion 525 possesses a highest point). In this way, a part by which the second tab 52 is higher than the second electrode assembly 22 can also be folded back to one side of the spacer plate 30 that is adjacent to the second electrode assembly 22, become flush with this side of the spacer plate 30, and then extend out of the packaging shell 40 in a manner of being parallel to and keeping in close fit with the spacer plate 30. The third bend portion 523 and the fourth bend portion 525 are disposed in the first accommodation portion 301, thereby effectively saving the space occupied by the second tab 52 in the packaging shell 40, and more efficiently utilizing the space inside the packaging shell 40. On the one hand, this achieves a thin electrochemical device 10 of a small thickness and reduces the size of the electrochemical device 10. On the other hand, this avoids the loss of the energy density caused by the long protruding length of the second tab 52 out of the packaging shell 40, and effectively increases the energy density of the electrochemical device 10.

It is hereby noted that the bending angles of the first bend portion 513, the second bend portion 515, the third bend portion 523, and the fourth bend portion 525 are not particularly limited herein, and may be selected by a person skilled in the art depending on the actual situation. Optionally, when the bending angle is approximately 90°, the bending portions can be disposed in the first accommodation portion 301 and/or the second accommodation portion 302 more conveniently, the size of the electrochemical device 10 can be reduced more favorably, and in turn, the energy density can be increased more effectively.

In some embodiments of this application, as shown in FIG. 14, along the thickness direction of the first electrode assembly 21, a longitudinal section of the first accommodation portion 301 is U-shaped. Both the first bend portion 513 and second bend portion 515 of the first tab 51 are disposed in the first accommodation portion 301. The first section 514 of the first tab 51 extends out of the packaging shell 40 from between an edge of the spacer plate 30 and the seal edge of the first packaging body 41. This ensures the sealing reliability of the electrochemical device 10 while reducing the size of the electrochemical device 10 to increase the energy density.

In some embodiments of this application, the number of the first tabs 51 is identical to the number of the first accommodation portions 301, and the first tabs 51 correspond one-to-one to the first accommodation portions 301. That is, one first tab 51 corresponds to one first accommodation portion 301, thereby avoiding mutual interference between the first tabs 51 and improving safety of the electrochemical device 10.

In some embodiments of this application, the number of the first tabs 51 is greater than the number of the first accommodation portions 301. At least one first accommodation portion 301 corresponds to two or more first tabs 301. That is, there is at least one first accommodation portion 301 to which two or more first tabs 301 need to be disposed correspondingly, thereby reducing the number of the first accommodation portions 301 and reducing the production cost caused by the provision of the first accommodation portion 301.

In some embodiments of this application, as shown in FIG. 1, FIG. 7, and FIG. 11, the number of the first tabs 51 is two, and the two first tabs 51 are of opposite polarities, for example, are a first positive tab 511 and a first negative tab 512 respectively. The number of the first accommodation portions 301 is two, and the first tabs 51 correspond to the first accommodation portions 301 respectively; or, Optionally, the number of the first accommodation portions 301 is one, and two first tabs 51 correspond to the same first accommodation portion 301.

Further, as shown in FIG. 1, FIG. 7, and FIG. 11, the number of the second tabs 52 is two, and the two second tabs 52 are of opposite polarities, for example, are a second positive tab 521 and a second negative tab 522 respectively. The number of the second accommodation portions 302 is two, and the second tabs 52 correspond to the second accommodation portions 302 respectively; or, Optionally, the number of the second accommodation portions 302 is one, and two second tabs 52 correspond to the same second accommodation portion 302.

Specifically, in some embodiments, as shown in FIG. 7 to FIG. 10, both the first positive tab 511 and the first negative tab 512 are disposed in the first accommodation portion 301. The first section 514 extends out of the packaging shell from between the edge of the spacer plate 30 and the seal edge of the first packaging body 41. Both the second positive tab 521 and the second negative tab 522 are disposed in the second accommodation portion 302, and the second section 524 thereof extends out of the packaging shell 40 from between the edge of the spacer plate 30 and the seal edge of the second packaging body 42. The first section 514 of the first positive tab 511 may be connected to the second section 524 of the second negative tab 522 to connect the first electrode assembly 21 and the second electrode assembly 22 in series. Moreover, the first section 514 of the first negative tab 512 and the second section 524 of the second positive tab 521 may be used as a positive electrode terminal and a negative electrode terminal respectively for implementing connection during charging and discharging. When both the first tab 51 and the second tab 52 extend out of the packaging shell 40 for welding, the welding effect of the first tab 51 and the second tab 52 can be monitored at any time, thereby reducing the risk of breakage of the first tab 51 and the second tab 52, and avoiding a problem that the internal resistance of the electrochemical device 10 increases due to poor welding of the first tab 51 and/or the second tab 52. The first electrode assembly 21 is connected to the second electrode assembly 22 in series, thereby effectively increasing the output voltage of the electrochemical device 10.

Further, the number of the first tabs 51 is one, and the number of the second tabs 52 is one; or, the number of the first tabs 51 is at least two, and the number of the second tabs 52 is at least two, as long as the electrochemical device 10 includes at least two tabs of opposite polarities.

In some embodiments of this application, as shown in FIG. 17, the spacer plate 30 includes an interlayer 31 and a bonding layer 32 located on a surface of the interlayer 31. The bonding layer 32 is disposed at least in an edge region of the interlayer 31 on all sides. It is hereby noted that the “surface” mentioned here may be the entire region of the interlayer 31, or a partial region of the interlayer 31. In other words, in the thickness direction of the spacer plate 30, a projected area of the bonding layer 32 is not greater than the area of the interlayer 31. In some embodiments, the bonding layer 32 is disposed in just the edge region of the surface of the interlayer 31 on all sides. Therefore, the spacer plate 30 can be hermetically connected to the seal edge of the first packaging body 41 and the seal edge of the second packaging body 42, so as to provide firmer sealing of the electrochemical device 10 as a whole, and in turn, further improve the sealing reliability of the electrochemical device 10.

In some embodiments of this application, the interlayer 31 is made of a material including at least one of a metal material, a polymer material, or a carbon material.

In some embodiments of this application, the material of the interlayer 31 includes a metal material. The metal material provides more reliable physical isolation, and is highly tough and compact, and can be processed to be thinner in thickness to increase the energy density of the electrochemical device 10. For example, the metal material may include at least one of Ni, Ti, Ag, Au, Pt, Fe, Co, Cr, W, Mo, Pb, In, Zn, Al, stainless steel, or an alloy thereof.

In some embodiments of this application, the material of the interlayer 31 includes a carbon material. The carbon material is of good safety performance, highly thermally conductive, and very reliable at high temperatures. For example, the carbon material may include at least one of carbon felt, carbon film, carbon black, acetylene black, fullerene, conductive graphite film, or graphene film.

In some embodiments of this application, the material of the interlayer 31 includes a polymer material. The polymer material is of a low density, and can reduce the weight of the spacer plate 30, thereby improving the energy density of the electrochemical device 10. In addition, the polymer material is less prone to generate scraps in a case of mechanical abuse (such as nail penetration, impact, and squeezing), and is more effective in wrapping a mechanically broken surface, thereby improving safety performance in the case of mechanical abuse, increasing the safety test pass rate, and further improving the safety performance of the electrochemical device 10. For example, the polymer material may include at least one of polyethylene terephthalate, polybutylene terephthalate, polyethylene glycol naphthalate, polyether ether ketone, polyimide, polyamide, polyethylene glycol, polyamide imide, polycarbonate, cyclic polyolefin, polyphenylene sulfide, polyvinyl acetate, polytetrafluoroethylene, polymethylene naphthalene, polyvinylidene difluoride, polyethylene naphthalate, polypropylene carbonate, poly(vinylidene difluoride-hexafluoropropylene), poly(vinylidene difluoride-co-chlorotrifluoroethylene), organosilicon, vinylon, polypropylene (PP), acid anhydride modified polypropylene, polyethylene, ethylene and a copolymer thereof, polyvinyl chloride, polystyrene, polyether nitrile, polyurethane, polyphenylene ether, polyester, polysulfone, poly(amorphous a-co-olefin), or a derivative thereof.

In some embodiments of this application, the bonding layer 32 is made of a material including at least one of polypropylene, acid anhydride modified polypropylene, polyethylene, poly(ethylene-co-vinyl acetate), poly(ethylene-co-ethyl acrylate), poly(ethylene-co-acrylate), poly(ethylene-co-vinyl alcohol), polyvinyl chloride, polystyrene, polyether nitrile, polyurethane, epoxy resin, polyamide, polyester, poly(amorphous a-co-olefin), or a derivative thereof, or the like. The above materials can be easily bonded to the inner surface of the packaging shell 40 such as an aluminum laminated film by heat sealing, thereby effectively improving the hermeticity between the spacer plate 30 and the packaging shell 40, and in turn, improving the sealing reliability of the electrochemical device 10. It is hereby noted that the temperature, time, and pressure applied to the sealing between the bonding layer 32 and the packaging shell 40 is not particularly limited herein, as long as the objectives of this application can be achieved. For example, the material of the bonding layer 32 is polypropylene, the sealing is performed at a temperature of 180° C. to 195° C. for a time period of 2 to 4 seconds under a pressure of 0.2 MPa to 0.5 MPa.

In some embodiments of this application, the thickness of the spacer plate is 30 μm to 100 μm and Optionally, 50 μm to 80 μm. For example, a lower limit of the thickness of the spacer plate 30 may be, but is not limited to, 30 μm, 40 μm, 50 μm, or 60 μm; and an upper limit of the thickness of the spacer plate 30 may be, but is not limited to, 65 μm, 75 μm, 80 μm, 85 μm, 90 μm, or 100 μm. When the spacer plate 30 is unduly thin (for example, thinner than 30 μm), the capability of the spacer plate 30 in partitioning off the electrolyte solution will be impaired, and the electrolyte solution in the sealed cavities on both sides of the spacer plate 30 is prone to penetrate the interlayer 31 of the spacer plate 30, consequently impairing the electrochemical performance of the electrochemical device 10. When the spacer plate 30 is unduly thick (for example, thicker than 10 μm), the volume of the electrochemical device 10 is increased, consequently reducing the energy density of the electrochemical device 100.

The thicknesses of the interlayer 31 and the bonding layer 32 are not particularly limited herein, as long as the objectives of this application can be achieved. For example, the thickness of the interlayer 31 may be 20 μm to 70 μm, and Optionally μm to 50 μm. The thickness of the bonding layer 32 may be 10 μm to 30 μm, and Optionally, 20 μm to 25 μm.

The material of the tab is not particularly limited herein, as long as the objectives of this application can be achieved. For example, the material of the positive tab includes at least one of aluminum (Al) or aluminum alloy. The material of the negative tab includes at least one of nickel (Ni), copper (Cu), or nickel-plated copper (Ni—Cu).

The connection manner of the tab is not particularly limited herein, as long as the objectives of this application can be achieved. For example, the connection manner may be at least one of laser welding, ultrasonic welding, resistance welding, conductive adhesive bonding, or the like. The directions of leading out different tabs are not particularly limited herein, as long as the objectives of this application can be achieved. For example, the lead-out directions of the tabs may be the same direction or different directions.

The structure of the electrode assembly is not particularly limited herein, as long as the objectives of this application can be achieved. For example, the structure of the electrode assembly may be at least one of a jelly-roll structure or a stacked-type structure.

In this application, the electrode assembly may include a separator, a positive electrode plate, and a negative electrode plate. The separator is configured to separate the positive electrode plate from the negative electrode plate to prevent an internal short circuit of the electrochemical device, and allow free passage of electrolyte ions so as to complete electrochemical charging and discharging processes. The numbers of the separators, positive electrode plates, and negative electrode plates are not particularly limited herein, as long as the objectives of this application can be achieved.

The packaging shell is not particularly limited herein, as long as the objectives of this application can be achieved. For example, the packaging shell may include an inner layer and an outer layer. The inner layer is hermetically connected to the spacer plate. Therefore, the material of the inner layer may include a polymer material, so as to achieve an excellent sealing effect. In addition, the combination of the inner layer and the outer layer can effectively protect an internal structure of the electrochemical device. Specifically, the material of the inner layer includes at least one of polypropylene, polyester, p-hydroxybenzaldehyde, polyamide, polyphenylene ether, polyurethane, or the like. The material of the outer layer is not particularly limited herein, as long as the objectives of this application can be achieved. For example, the material of the outer layer may include at least one of an aluminum foil, an aluminum oxide layer, a silicon nitride layer, or the like. In addition, the packaging shell may be an aluminum laminated film instead. The aluminum laminated film includes a nylon layer, an aluminum foil layer, and a PP layer.

The thickness of the packaging shell is not particularly limited herein, as long as the objectives of this application can be achieved. For example, the thickness of the packaging shell may be 50 μm to 500 μm and Optionally, 50 μm to 300 μm and more Optionally, 50 μm to 200 μm. The packaging shell falling within such a thickness range can effectively protect the internal structure of the electrochemical device.

The dimensions of the seal edge are not particularly limited herein, as long as the objectives of this application can be achieved. For example, the thickness T (unit: mm) and the width W (unit: mm) of the seal edge satisfy 0.01≤T/W≤0.05. With the ratio of T to W falling within the above range, it is ensured that the battery is well sealed and the service life of the battery is increased. Neither the sealing thickness nor the sealing width is particularly limited herein, as long as the objectives of this application can be achieved. For example, the width W of the seal edge is Optionally 1 mm to 7 mm. It is hereby noted that, in a sealing process, the polymer material in the packaging shell and the sealing material are sealed together by hot pressing. Therefore, the sealing thickness includes a thickness of a product of fusing the sealing material with the polymer material in the inner layer of the packaging shell. The sealing width means a width of a sealing region formed by fusing the sealing material and the polymer material in the inner layer of the packaging shell together after the hot-press sealing.

The electrochemical device of this application may further include other devices that undergo electrochemical reactions, such as a lithium metal secondary battery, a lithium polymer secondary battery, or a lithium-ion polymer secondary battery.

The preparation process of the electrochemical device is not particularly limited herein, as long as the objectives of this application can be achieved. For example, the preparation process of the electrochemical device may include: stacking a positive electrode plate and a negative electrode plate that are separated by a separator, performing operations such as winding or folding into an assembly as required, putting the assembly into the housing, injecting an electrolyte solution into the housing, and sealing the opening. In addition, an overcurrent prevention element, a guide plate, and the like may be placed into the housing as required, so as to prevent the rise of internal pressure, overcharge, and overdischarge of the electrochemical device.

As an example, in an embodiment of this application, as shown in FIG. 1 to FIG. 10, the electrochemical device 10 includes a first electrode assembly 21 and a second electrode assembly 22 stacked one on another. Each electrode assembly is formed by stacking a plurality of layers of positive electrode plate, separator, and negative electrode plate sequentially. An upper electrode assembly is separated from a lower electrode assembly by a spacer plate 30. The electrochemical device is manufactured by steps such as electrolyte injection, chemical formation, and sealing. The two electrodes of the first electrode assembly 21 are led out through the corresponding first positive tab 511 and first negative tab 512. A tab adhesive is applied to the corresponding positions on the first positive tab 511 and the first negative tab 512. The two electrodes of the second electrode assembly 22 are led out through the corresponding second positive tab 521 and second negative tab 522. A tab adhesive is applied to the corresponding positions on the second positive tab 521 and the second negative tab 522. The first packaging body 41 and the spacer plate 30 constitute a first cavity for accommodating the first electrode assembly 21, the first positive tab 511, the first negative tab 512, and an electrolyte solution. The second packaging body 42 and the spacer plate 30 constitute a second cavity for accommodating the second electrode assembly 22, the second positive tab 521, the second negative tab 522, and the electrolyte solution. Both the first packaging body 41 and the second packaging body 42 are aluminum laminated films. The spacer plate 30 is a composite material of a three-layer structure, in which the interlayer 31 is 40 μm-thick stainless steel, and the bonding layer 32 is 20 μm-thick modified PP. The metal foil extending from the current collector of the first electrode assembly 21 is bent and stacked, and then welded to a current collecting plate to serve as a first tab 51 of the first electrode assembly 21. The first tab 51 is bent at 90° along the outer side of the weld mark, and then led out directly, thereby forming a first bend portion 513 and a first section 514 on the first tab 51. The first section 514 extends out of the packaging shell. Meanwhile, the second tab 52 is similarly designed, the details of which are omitted here. The first electrode assembly 21 and the second electrode assembly 22 are relatively thin. Consequently, in the thickness direction of the electrode assembly, the first bend portion 513 exceeds the first electrode assembly 21 by a distance h₁=0.8 mm; and the third bend portion 523 exceeds the second electrode assembly 22 by a distance h₂=0.8 mm. Therefore, if the spacer plate is flat and even, a clearance exists between the spacer plate and the electrode assembly, thereby leading to a decline in the energy density. For this reason, a first accommodation portion 301 and a second accommodation portion 302 that are opened on the outer side are disposed on the spacer plate 30 of this application at positions corresponding to the first bend portion and the lead-out position of the first tab 51 and the second tab 52. Accordingly, a matching recessed portion/bulge is disposed on the seal edge of the first packaging body 41 and the seal edge of the second packaging body 42 at positions corresponding to the first accommodation portion 301 and the second accommodation portion 302, so as to wrap the spacer plate 30, the first tab 51, and the second tab 52, thereby achieving the desired sealing effect for the electrochemical device 10. The sealed first electrode assembly 21 and second electrode assembly 22 are connected in series by the first positive tab 511 and the second negative tab 522 in an external circuit. The second positive tab 521 and the first negative tab 512, which are of opposite polarities, serve as the positive and negative output terminals to output a high voltage. In this embodiment, a total thickness of the electrochemical device 10 is just 4.5 mm, thereby being significantly superior in thickness.

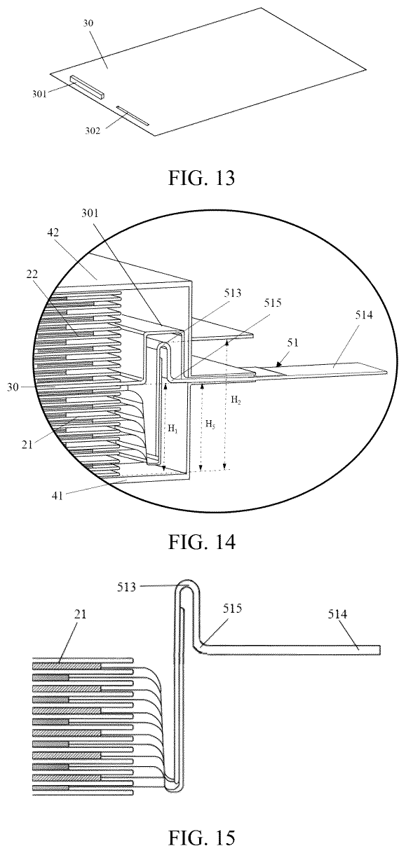

In another embodiment of this application, as shown in FIG. 11 to FIG. 16, the electrochemical device 10 includes a first electrode assembly 21 and a second electrode assembly 22 stacked one on another. Each electrode assembly is formed by stacking multiple layers of positive electrode plate, separator, and negative electrode plate sequentially. An upper electrode assembly is separated from a lower electrode assembly by a spacer plate 30. The electrochemical device is manufactured by steps such as electrolyte injection, chemical formation, and sealing. The two electrodes of the first electrode assembly 21 are led out through the corresponding first positive tab 511 and first negative tab 512. A tab adhesive is applied to the corresponding positions on the first positive tab 511 and the first negative tab 512. The two electrodes of the second electrode assembly 22 are led out through the corresponding second positive tab 521 and second negative tab 522. A tab adhesive is applied to the corresponding positions on the second positive tab 521 and the second negative tab 522. The first packaging body 41 and the spacer plate 30 constitute a first cavity for accommodating the first electrode assembly 21, the first positive tab 511, the first negative tab 512, and an electrolyte solution. The second packaging body 42 and the spacer plate 30 constitute a second cavity for accommodating the second electrode assembly 22, the second positive tab 521, the second negative tab 522, and the electrolyte solution. Both the first packaging body 41 and the second packaging body 42 are aluminum laminated films. The spacer plate 30 is a composite material of a three-layer structure, in which the interlayer 31 is 40 μm-thick aluminum alloy, and the bonding layer 32 is 20 μm-thick modified PP. To enable sealing between the edge of the spacer plate and the packaging shell in a flat and even manner to reduce the difficulty of sealing, and to enable the individual tabs to be in the same plane after the entirety is sealed, the tab is bent several times. As shown in FIG. 15, the first tab 51 forms a first bend portion 513, a second bend portion 515, and a first section 514. The first section 514 is flush with the spacer plate 30, and is led out parallel to the spacer plate 30. In other words, the tab portion beyond the electrode assembly assumes a U-shaped fold-back structure. The first electrode assembly 21 and the second electrode assembly 22 are relatively thin. Consequently, in the thickness direction of the electrode assembly, the first bend portion 513 exceeds the first electrode assembly 21 by a distance h₁=0.7 mm; and the third bend portion 523 exceeds the second electrode assembly 22 by a distance h₂=0.7 mm. Accordingly, a first accommodation portion 301 and a second accommodation portion 302 that do not extend to the edge of the spacer plate are disposed on the spacer plate at a position corresponding to the fold-back position of the U-shaped tab (the second bend portion 515/fourth bend portion 525), and serve a function of accommodation. As shown in FIG. 13 and FIG. 14, a second accommodation portion 302 opened upward is disposed on the spacer plate 30 at a position corresponding to the second tab 52, and a first accommodation portion 301 opened downward is disposed on the spacer plate at a position corresponding to the first tab 51. In this way, the edge of the spacer plate 30 can still keep flat and even, and each recessed portion is sealed inside the packaging shell 40. The flat and even edge greatly reduces the difficulty of sealing between the spacer plate 30 and the packaging shell 40. In addition, all the tabs are substantially located in the same plane on the outside of the packaging shell 40. The sealed first electrode assembly 21 and second electrode assembly 22 are connected in series by the first positive tab 511 and the second negative tab 522 in an external circuit. The second positive tab 521 and the first negative tab 512, which are of opposite polarities, serve as the positive and negative output terminals to output a high voltage. In this embodiment, a total thickness of the electrochemical device 10 is 2.0 mm, and the small thickness provides more possibilities for the adaptability of the electrochemical device 10.

A second aspect of this application provides an electronic device. The electronic device includes the electrochemical device according to the first aspect of this application. The electronic device achieves a high energy density.

The electronic devices of this application are not particularly limited, and may include, but are not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household battery, lithium-ion capacitor, and the like.

It is hereby noted that the relational terms such as “first”, “second”, “third”, and “fourth” used herein are merely intended to differentiate one entity from another, but do not require or imply any actual relationship or sequence between the entities. Moreover, the terms “include”, “comprise”, and any variation thereof are intended to cover a non-exclusive inclusion relationship in which an object or device that includes or comprises a series of elements not only includes such elements, but also includes other elements not expressly specified herein or inherent elements of the object or device.

Different embodiments of this application are described in a correlative manner. For the same or similar part in one embodiment, reference may be made to another embodiment. Each embodiment focuses on differences from other embodiments.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. An electrochemical device, comprising:
a packaging shell, wherein the packaging shell comprises a first packaging body and a second packaging body;
a spacer plate, wherein the spacer plate is disposed between the first packaging body and the second packaging body, two surfaces of the spacer plate are hermetically connected to the first packaging body and the second packaging body respectively, so as to define a first cavity and a second cavity on two sides of the spacer plate respectively;
a first electrode assembly and a second electrode assembly, wherein the first electrode assembly is disposed in the first cavity and the second electrode assembly is disposed in the second cavity; and
a first tab and a second tab, wherein the first tab is connected to the first electrode assembly, and the second tab is connected to the second electrode assembly; along a thickness direction of the first electrode assembly, a first bend portion is disposed on the first tab, a height of the first bend portion is greater than a thickness of the first electrode assembly, and the height of the first bend portion is a maximum distance from the first bend portion to a surface of the first electrode assembly in the thickness direction of the first electrode assembly, the surface facing the first packaging body; wherein
a first accommodation portion protruding toward the second packaging body is disposed on the spacer plate, and the first bend portion is disposed in the first accommodation portion.

2. The electrochemical device according to claim 1, wherein the first tab comprises a first section connected to the first bend portion, and the first section protrudes out of the packaging shell after passing through a sealed region between the spacer plate and the first packaging body.

3. The electrochemical device according to claim 2, wherein a second recessed portion configured for steping aside the first accommodation portion is disposed on the second packaging body, the second recessed portion is hermetically connected to the first accommodation portion, a first bulge in fit with the first accommodation portion is disposed on the first packaging body, and the first section extends out of the packaging shell from between the first bulge and the first accommodation portion.

4. The electrochemical device according to claim 2, wherein the first tab further comprises a second bend portion, the second bend portion is connected to the first bend portion and the first section, a height of the second bend portion is less than a height of the first bend portion along the thickness direction of the first electrode assembly, and the height of the second bend portion is a distance from the surface of the first electrode assembly to a lowest point of the second bend portion, the surface facing the first packaging body.

5. The electrochemical device according to claim 4, wherein, along the thickness direction of the first electrode assembly, a longitudinal section of the first accommodation portion is U-shaped, both the first bend portion and second bend portion are disposed in the first accommodation portion, and the first section extends out of the packaging shell from between an edge of the spacer plate and the first packaging body.

6. The electrochemical device according to claim 1, wherein a number of the first tabs is identical to a number of the first accommodation portions, and the first tabs correspond one-to-one to the first accommodation portions; or, a number of the first tabs is greater than a number of the first accommodation portions, and at least one first accommodation portion corresponds to two or more first tabs.

7. The electrochemical device according to claim 6, wherein the number of the first tabs is two, and the two first tabs are of opposite polarities; the number of the first accommodation portions is two, and the first tabs correspond to the first accommodation portions respectively; or, the number of the first accommodation portions is one, and the two first tabs correspond to the same first accommodation portion.

8. The electrochemical device according to claim 1, wherein the spacer plate comprises an interlayer and a bonding layer located on a surface of the interlayer, and the bonding layer is disposed at least in an edge region of the interlayer on all sides.

9. The electrochemical device according to claim 8, wherein the interlayer is made of a material comprising at least one of a metal material, a polymer material, or a carbon material; the metal material comprising at least one of Ni, Ti, Ag, Au, Pt, Fe, Co, Cr, W, Mo, Pb, In, Zn, Al, stainless steel, or an alloy thereof; the polymer material comprising at least one of polyethylene terephthalate, polybutylene terephthalate, polyethylene glycol naphthalate, polyether ether ketone, polyimide, polyamide, polyethylene glycol, polyamide imide, polycarbonate, cyclic polyolefin, polyphenylene sulfide, polyvinyl acetate, polytetrafluoroethylene, polymethylene naphthalene, polyvinylidene difluoride, polyethylene naphthalate, polypropylene carbonate, poly(vinylidene difluoride-hexafluoropropyl ene), poly(vinylidene difluoride-co-chlorotrifluoroethylene), organosilicon, vinylon, polypropylene, acid anhydride modified polypropylene, polyethylene, ethylene and a copolymer thereof, polyvinyl chloride, polystyrene, polyether nitrile, polyurethane, polyphenylene ether, polyester, polysulfone, poly(amorphous a-co-olefin), or a derivative thereof; the carbon material comprising at least one of carbon felt, carbon film, carbon black, acetylene black, fullerene, conductive graphite film, or graphene film.

10. An electronic device, wherein the electronic device comprising the electrochemical device according to claim 1.

11. The electronic device according to claim 10, wherein the first tab comprising a first section connected to the first bend portion, and the first section protrudes out of the packaging shell after passing through a sealed region between the spacer plate and the first packaging body.

12. The electronic device according to claim 11, wherein a second recessed portion configured for steping aside the first accommodation portion is disposed on the second packaging body, the second recessed portion is hermetically connected to the first accommodation portion, a first bulge in fit with the first accommodation portion is disposed on the first packaging body, and the first section extends out of the packaging shell from between the first bulge and the first accommodation portion.

13. The electronic device according to claim 11, wherein the first tab further comprising a second bend portion, the second bend portion is connected to the first bend portion and the first section, a height of the second bend portion is less than a height of the first bend portion along the thickness direction of the first electrode assembly, and the height of the second bend portion is a distance from the surface of the first electrode assembly to a lowest point of the second bend portion, the surface facing the first packaging body.

14. The electronic device according to claim 13, wherein, along the thickness direction of the first electrode assembly, a longitudinal section of the first accommodation portion is U-shaped, both the first bend portion and second bend portion are disposed in the first accommodation portion, and the first section extends out of the packaging shell from between an edge of the spacer plate and the first packaging body.

15. The electronic device according to claim 10, wherein a number of the first tabs is identical to a number of the first accommodation portions, and the first tabs correspond one-to-one to the first accommodation portions; or, a number of the first tabs is greater than a number of the first accommodation portions, and at least one first accommodation portion corresponds to two or more first tabs.

16. The electronic device according to claim 15, wherein the number of the first tabs is two, and the two first tabs are of opposite polarities; the number of the first accommodation portions is two, and the first tabs correspond to the first accommodation portions respectively; or, the number of the first accommodation portions is one, and two first tabs correspond to the same first accommodation portion.

17. The electronic device according to claim 10, wherein the spacer plate comprising an interlayer and a bonding layer located on a surface of the interlayer, and the bonding layer is disposed at least in an edge region of the interlayer on all sides.

18. The electronic device according to claim 17, wherein the interlayer is made of a material comprising at least one of a metal material, a polymer material, or a carbon material; the metal material comprising at least one of Ni, Ti, Ag, Au, Pt, Fe, Co, Cr, W, Mo, Pb, In, Zn, Al, stainless steel, or an alloy thereof; the polymer material comprising at least one of polyethylene terephthalate, polybutylene terephthalate, polyethylene glycol naphthalate, polyether ether ketone, polyimide, polyamide, polyethylene glycol, polyamide imide, polycarbonate, cyclic polyolefin, polyphenylene sulfide, polyvinyl acetate, polytetrafluoroethylene, polymethylene naphthalene, polyvinylidene difluoride, polyethylene naphthalate, polypropylene carbonate, poly(vinylidene difluoride-hexafluoropropyl ene), poly(vinylidene difluoride-co-chlorotrifluoroethylene), organosilicon, vinylon, polypropylene, acid anhydride modified polypropylene, polyethylene, ethylene and a copolymer thereof, polyvinyl chloride, polystyrene, polyether nitrile, polyurethane, polyphenylene ether, polyester, polysulfone, poly(amorphous a-co-olefin), or a derivative thereof; the carbon material comprising at least one of carbon felt, carbon film, carbon black, acetylene black, fullerene, conductive graphite film, or graphene film.
